(19) United States
(12) Patent Application Publication
(10) Pub. No.: US 2010/0046816 A1
(43) Pub. Date: Feb. 25, 2010

(54) METHOD FOR AUTOMATIC CLASSIFICATION OF IN VIVO IMAGES

(76) Inventors: Laura IGUAL-MUNOZ, Barcelona (ES); Jordi VITRIA, Barcelona (ES); Fernando VILARINO, Lugo (ES); Santiago SEGUI-MESQUIDA, Illes Balears (ES); Carolina MALAGELADA, Barcelona (ES); Fernando AZPIROZ, Barcelona (ES); Petia RADEVA, Barcelona (ES)

Correspondence Address: Pearl Cohen Zedek Latzer, LLP, 1500 Broadway, 12th Floor, New York, NY, 10036, US

(21) Appl. No.: 12/543,977

(22) Filed: Aug. 19, 2009

Related U.S. Application Data
(60) Provisional application No. 61/089,946, filed on Aug. 19, 2008.

(51) Int. Cl. G06K 9/00

(52) U.S. Cl. 382/128

(57) ABSTRACT

A method for automatically detecting a post-duodenal boundary in an image stream of the gastrointestinal (GI) tract. The image stream is sampled to obtain a reduced set of images for processing. The reduced set of images is filtered to remove non-valid frames or non-valid portions of frames, thereby generating a filtered set of valid images. A polar representation of the valid images is generated. Textural features of the polar representation are processed to detect the post-duodenal boundary of the GI tract.

### FIELD OF THE INVENTION

The present invention relates in general to in-vivo imaging, and specifically to feature extraction from image frames captured in-vivo and to automatic characterization of organs from a stream of in vivo images.

### BACKGROUND OF THE INVENTION

Recently, a novel technique named capsule endoscopy has proved its efficiency as an alternative endoscopic technique. The use of capsule endoscopy analysis of the intestinal tract avoids the disadvantages of conventional invasive techniques.

With capsule endoscopy, a pill with a micro-camera located inside it is swallowed by the patient. The capsule housing may incorporate an illumination source, power supply, and a radio-frequency or other frequency transmitter to send, for example, a stream of image frames to an external device for storage and analysis. The capsule endoscope may be passively and/or naturally passed along the GI tract by, for example, peristaltic motion while capturing image frames from within the body lumen of, for example, the body lumen walls. As the pill traverses the gastrointestinal tract, it takes pictures (images) thereof at a rate of a given number of frames per second.

The pictures are transmitted to an external recording device where they are stored. The series of pictures taken as the pill traverses the gastrointestinal tract form frames of a movie. The image frames captured may be, for example, downloaded into a workstation for review by specialists. In some examples, the image stream captured may be used for diagnostic purposes.

Automatic analysis of the image stream using patterns of intestinal contractions has been suggested. There exist algorithms for detection of specific organs in the GI tract. However, there is no method of detecting specific areas of these organs. For example, there is no method for separating the duodenum and ileum-jejunum of the small bowel (post-duodenal threshold). Exactly locating an area within different organs of the GI tract may enable application of clinical procedures (feeding special nutrients, etc.) in a more accurate and efficient way.

Other devices, systems and methods for in-vivo sensing of passages or cavities within a body and for sensing and gathering information (e.g., image information, pH information, temperature information, electrical impedance information, pressure information, etc.) are known in the art.

### SUMMARY OF THE INVENTION

Embodiments of the present invention provide a method which combines texture and motility features of in vivo images to determine location in the GI tract.

In some cases, a stream of images showing sustained contractions may be visually similar to images of the duodenum. Given that sustained contractions have clinical relevance in diagnosing patients, it is of interest to be able to separate these two phenomena.

Additionally, from a clinical point of view, separating the duodenum from the rest of the intestines may allow application of clinical procedures (feeding special nutrients, etc.) in an efficient manner.

According to one embodiment of the invention there is provided a method of analyzing a stream of in vivo images. The method may include the following steps: (1) a stream of images (also referred to as a “video”) is re-sampled and frames with artefacts which prevent correct visualization of the intestine wall (for example, intestinal contents) are filtered; and (2) The remaining frames are processed by applying a bank of filters, such as Gabor filters, followed by rectification, such as by half wave rectification.

Methods according to embodiments of the invention bring out textural differences. According to some embodiments, textural differences of the duodenum relative to the rest of the intestine are found and the post duodenal threshold may be located.

### BRIEF DESCRIPTION OF THE FIGURES

FIG. 1 illustrates a scheme of a method of detecting a boundary of between proximal and distal regions of the small bowel using textural descriptors, according to one embodiment of the invention;

FIGS. 2A, 2B are examples of in vivo imaging capsule frames and their polar representation (2C, 2D). The proximal part of the small bowel is shown in FIGS. 2A, 2C vs. the distal part of the small bowel (jejunum-ileum) shown in FIGS. 2B, 2D.

FIG. 3A is an example of a frame with artefacts (bubbles) and FIG. 3B is an example of the detected non-valid area. H

FIG. 4 illustrates a video classification result, with the error function E and the expert and the system boundaries.

### DETAILED DESCRIPTION OF THE INVENTION

According to embodiments of the present invention, an in-vivo imaging device, e.g., a Wireless Capsule Video Endoscope (WCVE) may be used as data source (Pillcam^{R}, Given Imaging, Yoqneam, Israel). WCVE consists of a capsule with a camera, a battery and light emitting diode (LED) lamps for illumination, which may be swallowed by a patient, emitting a radio frequency signal that may be received by an external device. This technique is much less invasive than conventional endoscopy, since the patient simply has to swallow the pill, which may be excreted in the normal cycle through the anus; moreover, hospitalization may not be required, and the patient may engage in his/her daily routine, while a portable device worn by the patient may record the video movie emitted by the pill.

Although a portion of the discussion may relate to autonomous in-vivo imaging devices, systems and methods, the present invention is not limited in this regard, and embodiments of the present invention may be used in conjunction with various other imaging devices, systems and methods. For example, some embodiments of the invention may be used, for example, in conjunction with an endoscope or other devices used for imaging body lumens, for example, to detect a medical condition or pathology using image analysis. Embodiments of the invention may be provided, for example, displayed to a user on a display device of a workstation. For example, a health care specialist may use an automatically computed estimated post-duodenal boundary, for example, during review, analysis or diagnosis of an in vivo image stream.

The device, system and method of the present invention may be utilized in conjunction with other suitable imaging or sensing devices, systems and methods. Some embodiments of the present invention are directed to an autonomous in-vivo sensing device, e.g., a typically swallowable in-vivo imaging device. Devices, systems and methods of the present invention may be used with an imaging system such as that described in U.S. patent application Ser. No. 09/800,470, entitled “Device and System for In Vivo Imaging”, filed on Mar. 8, 2001. A further example of an imaging system, with which or in which devices, systems and methods of the present invention may be used, is described in U.S. Pat. No. 5,604,531 to Iddan et al., entitled “In-Vivo Video Camera System”, issued on Feb. 18, 1997 and/or U.S. Pat. No. 7,009,634, entitled “Device for In-Vivo Imaging”, issued on Mar. 7, 2006. Both these publications are assigned to the common assignee of the present application and are incorporated herein by reference in their entireties.

Furthermore, a receiving and/or display system suitable for use with embodiments of the present invention may also be similar to embodiments described in U.S. Patent Application Publication No. US2001/0035902. Devices and systems as described herein may have other configurations and other sets of components. Alternate embodiments of a device, system and method may be used with other devices, for example, non-imaging and/or non-in-vivo devices. For example, some embodiments of the present invention may be practiced using an endoscope, a probe, a needle, a stent, a catheter, etc.

Some embodiments of the present invention may be or may include an autonomous swallowable capsule, but may have other shapes and need not be swallowable or autonomous. Embodiments are typically self-contained, but need not be. For example, a device according to some embodiments may be a capsule or other unit where all the components are substantially contained within a container or shell, and where the device does not require any wires or cables to, for example, receive power or transmit information.

According to embodiments of the present invention, an in-vivo imaging device, e.g., a capsule endoscope, may pass through the GI tract by natural peristaltic motion while imaging the body lumen through which it may be passing. An image stream captured by an in-vivo imaging device may include images of contractile activity of the body lumen walls.

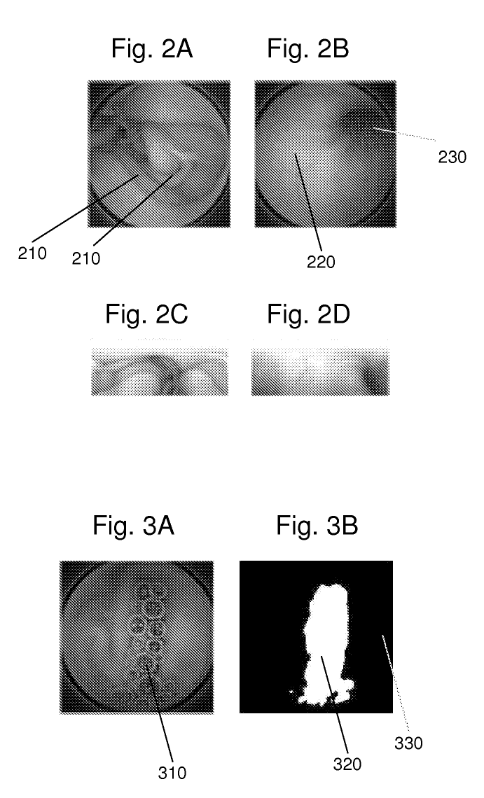

WCVE frames may visualize three essential parts of the gastro-intestinal (GI) tract: for example, the intestinal wall, lumen and intestinal contents. The texture of the gut wall may be different between the proximal region of the small bowel (e.g., duodenum) shown for example in FIG. 2A, and the rest of the small bowel (e.g., jejunum-ileum) as shown in the example displayed in FIG. 2B. Proximal region (duodenum) tissue contains a significant amount of wrinkles, and the small finger-like folds 210 entrusted with food absorption may be more visible in the proximal region than in the distal region of the small bowel, which may typically include a less wrinkled and smooth tissue wall 220 and a dark lumen hole 230.

Different texture of intestinal images can be caused, for example, by artefacts in the images, such as intestinal contents (turbidity and bubbles), or may be caused by wrinkles of the intestinal wall. Embodiments of the invention remove the textural component caused by the intestinal contents and focus the textural analysis on the wrinkles.

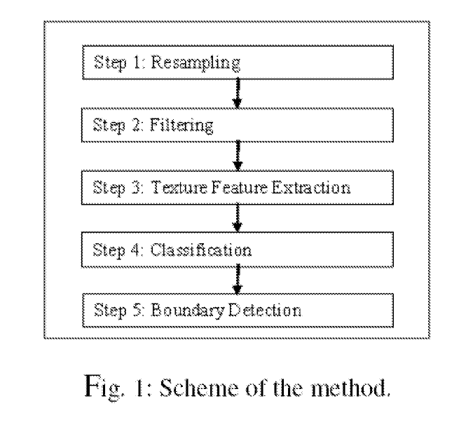

An embodiment of the invention will be described by the following non limiting example (as shown in FIG. 1):

Step 1 includes a re-sampling process. A sub-sampling of the image stream is performed, taking into account that the frame ratio captured by the in vivo imaging capsule is, for example, two frames per second. For example, one out of every n frames may be kept, e.g., one frame of every five captured frames may be kept, in order to efficiently reduce the number of images processed, thereby efficiently reducing the computation time, substantially without a loss in accuracy. Other ratios of frames may be kept for processing, for example, depending on the original frame rate of the video stream.

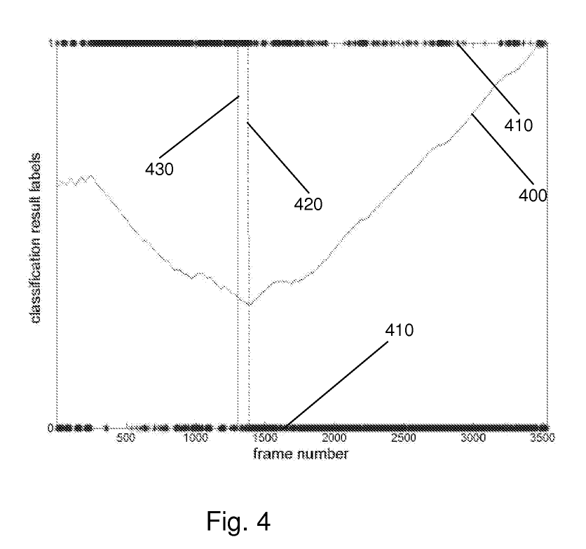

Step 2 includes a filtering process. Non-valid frames or non-valid portions of frames, for example frames with artefacts such as turbid intestinal contents and bubbles, which can prevent the correct visualization of the intestinal wall, may be detected and filtered (e.g., removed from the stream), leaving clear frames or clear portions of frames for further processing. For turbid intestinal contents detection, a semi-supervised procedure using a Self-Organized Map Method (SOM) may be used, where the distance measure is computed based on a color space. Some frames with intestinal juices are not filtered by this method due to a low presence of the intestinal juices or a different color characterization, as for instance could be the case of bubbles. Some frames with bubbles show a color that is slightly different from the general turbid paradigm of the image stream. However, these bubbles may have impact in the textural analysis and may hinder the correct classification of the frames. In order to detect bubble frames, a method based on Gabor filters for the characterization of the bubble-like shape of intestinal juices may be used. This method returns the segmented areas with intestinal juice bubbles for the video frames. Then, the following criterion for the reject decision may be used: if more than a predetermined threshold, for example, 50% of the frame, is characterized as bubble area, then this frame is filtered (e.g., removed and not further processed). Other percentages may be used. In some embodiments, the bubble areas of a frame may be used to define non-valid areas for textural analysis. The non-valid areas may be avoided in the subsequent processing, and only the pixels in valid areas may be used. For example, as shown in FIG. 3A a frame with a bubble area 310 may be processed, and the detected non-valid area 320 of the bubbles, shown in FIG. 3B, may be filtered. The remaining area which is valid for further processing may include area 330 in FIG. 3B.

Step 3 includes textural feature extraction in the valid images or valid image portions. The free movement of the camera and the intestine motion may make the identification of the wrinkle paradigm of the proximal region of the small bowel (duodenum) difficult, in the sense that the scene may change depending on the focus and the tilt of the in vivo camera. Therefore, a main interest is to find frame descriptors which may be invariant to translations and rotations. For these reasons, the textural descriptors are computed by applying a bank of Gabor filters on the polar representation of images, as shown for example in FIGS. 2C and 2D.

A Gabor filter is a sinusoidal plane of particular frequency and orientation, modulated by a Gaussian envelope. Other filters having good localization properties in both spatial and frequency domain and which may be applied in multiple tasks, such as texture segmentation, edge detection, object detection, and image representation, may be used.

We denote H(x, y, σ, φ) the response of a Gabor filter, where σ is the standard deviation of the Gaussian kernel and φ represents the orientation.

For the construction of the bank of even-symmetric linear filters, we use two different scales and four different directions σ=[12.7205, 6.3602] and φ=[0, π/4, π/2, 3*π/4], with an overall result of 8 filters in the bank. These parameters may be obtained throughout an extensive empirical search.

A convolution of the gray-scale version of the images with the bank of filters was performed resulting in Rᵢ(x,y)=1*Hᵢ(x, y, σ, φ), where Hᵢ denotes the Gabor filter iε{1, . . . , 8}.

After the filter application, a half-wave rectification is performed to avoid possible cancellations of positive and negative values. That is, the positive and negative parts of the filter response are split into Rᵢ⁺(x,y) and Rᵢ⁻(x,y).

Finally, a 16-dimensional descriptor vector is obtained d(t)=(d₁(t), . . . , d₈(t)) for each frame at time t by computing the following averages of the filter responses

$${d}_{i} ( i ) = ( \frac{1}{{N}_{X}} {\sum }_{x}^{{N}_{X}} {R}_{i}^{+} ( x ) , \frac{1}{{N}_{X}} {\sum }_{x}^{{N}_{X}} {R}_{i}^{-} ( x ) ) , \qquad ( 1 )$$

where x=(x,y) and N_{X} are the number of pixels of the valid areas of the frame.

This descriptor vector is used as texture features and highlight the differences of the duodenum with respect to the rest of the intestine.

Step 4 includes classification of the image frames. This step of the system uses the textural features for classifying each frame as belonging to the proximal part of the small bowel or not. Two different approaches are considered, an unsupervised classification and a supervised classification.

In the unsupervised classification approach, the descriptor information is used to clusterize the video in four parts using a Normalized Cuts algorithm.

Min-cut may be selected as a clustering method, due to the following reasoning: a major drawback to clustering methods such as k-means is that these clustering methods cannot separate clusters that are non-linearly separable in an input space. A recent approach has emerged for tackling such a problem: the spectral clustering algorithms, which use the eigenvectors of an affinity matrix to obtain a clustering of the data. A popular objective function used in spectral clustering is to minimize the normalized cut.

One label lᵢ, iε{1, . . . , 4} is associated to each cluster, then the number of labels is reduced to only two in the following way: all the frames belonging to the two clusters with the highest cardinality (assume, for example, 11 and 12) will keep their letter. Those frames belonging to the clusters with the lower cardinality will adopt one of the letters of the other clusters as follows:

$$L ( t ) = \{ \begin{matrix}{l}_{1} & if {P}_{{l}_{2}} ( I ) < {P}_{{l}_{1}} ( I ) and I = [ t - 10 , t + 10 ] , \\ {l}_{2} & otherwise\end{matrix}$$

where Pₗ_{₁}(I)=P(L(t)=l₁|tεI).

In this way, the video is dichotomized in two different classes. A further refinement is applied by means of a morphological closing in order to remove spurious frames.

In the supervised classification approach, the descriptor information is used in the training and test of a SVM classifier.

Step 5 includes post-duodenal boundary detection. The results of the classification may be used for estimating the post-duodenal boundary. The most probable position of the boundary may be estimated by computing the best fit to a step function. Given the labels of the classification L(t) for each frame at time t, an error function is defined:
E(t)=|L−S(t)|, where S(t) is the step function defined as follows:

$$S ( t ) = \{ \begin{matrix}0 & if x < t \\ 1 & if x \geq t\end{matrix}$$

Then, the first post-duodenal frame is detected as the frame at time t₀ such that t₀=argminₜE(t).

Experimental tests of the proposed method were performed on 13 different videos of healthy volunteers recorded in the same conditions (fasting preparation). The total of frames to analyze was 349100 and after re-sampling: 69820. On average, each video had 5370 frames to be analyzed. Additionally, the images were classified by experts and the following were identified: first post-gastric image, first post-duodenal image and first cecal image.

Both approaches for classifying duodenum vs. jejunum-ileum at frame level were tested: unsupervised classification and supervised classification.

Unsupervised Classification

Table 1 shows the results of the mean (μ) and median (μ_{1/2}) of the classification of the 13 videos in terms of Error, Sensitivity, Specificity, Precision and False Alarm Ratio.

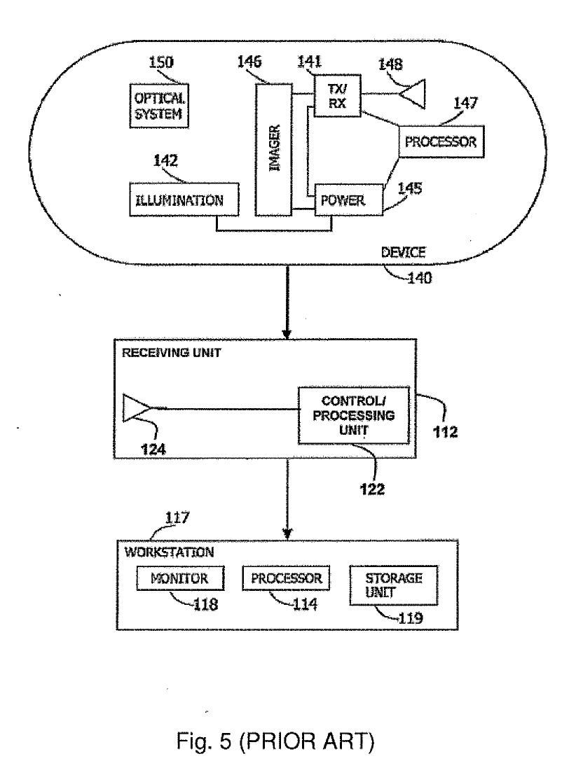

In FIG. 4, the result of the classification for one of the videos is shown. The stars 410 indicate the classification results at frame level. The minimum of the function E (400), depicted in the graph, points to the post-duodenal boundary that has been emphasized with the dashed line 420. The solid line 430 indicates the position of the boundary as defined by the specialist.

After the post-duodenal boundary estimation (Step 5), the error measures were recomputed and the mean and median of the results were improved as shown in Table 2. The error between the estimated boundary and the one indicated by the specialist in minutes was also computed for all the videos. The mean and median are 26.09 and 18.04 minutes respectively.

Supervised Classification

A Leave-One-Video-Out Cross Validation was performed with a Support Vector Machine classifier for the same data and the mean and median of the obtained results are displayed in Table 3.

In Table 4, the mean and median of the results after computing the most probable position of the transition point (Step 5) are shown. The mean and median of the errors made in the boundary estimation are 28.28 and 21.13 minutes respectively.

FIG. 5 schematically illustrates an in-vivo system in accordance with some embodiments of the present invention. One or more components of the system may be used in conjunction with, or may be operatively associated with, the devices and/or components described herein or other in-vivo devices in accordance with embodiments of the invention.

In some embodiments, the system may include a device 140 having a sensor, e.g., an imager 146, one or more illumination sources 142, a power source 145 and a transceiver 141. In some embodiments, device 140 may be implemented using a swallowable capsule, but other sorts of devices or suitable implementations may be used. Outside a patient's body may be, for example, an external receiver/recorder 112. A storage unit 119 which may be or include, for example, one or more of a memory, a database, etc. or other storage systems, a processor 114 and a display monitor 118. In some embodiments, for example, processor 114, storage unit 119 and/or monitor 118 may be implemented as a workstation 117, e.g., a computer or a computing platform.

Transceiver 141 may operate using radio waves; but in some embodiments, such as those where device 140 is or is included within an endoscope, transceiver 141 may transmit/receive data via, for example, wire, optical fiber and/or other suitable methods. Other known wireless methods of transmission may be used. Transceiver 141 may include, for example, a transmitter module or sub-unit and a receiver module or sub-unit, or an integrated transceiver or transmitter-receiver. In one embodiment, transceiver 141 includes at least a modulator for receiving an image signal from the sensor 146, a radio frequency (RF) amplifier, an impedance matcher and an antenna 148. The modulator converts the input image signal having a cutoff frequency f_{c} of less than 5 MHz to an RF signal having a carrier frequency fᵣ, typically in the range of 1 GHz. The carrier frequency may be in other bands, e.g., a 400 MHz band. The modulated RF signal has a bandwidth of fₜ. The impedance matcher matches the impedance of the circuit to that of the antenna. Other transceivers or arrangements of transceiver components may be used. In other embodiments, sensors other than image sensors may be used, such as pH meters, temperature sensors, pressure sensors, etc. and input RF signals other than image signals may be used.

The transceiver 141 may send different types of signals, including for example telemetry signals, image signals and beacon signals. Information sent from the device 140 may include information sensed by sensors in the device such as images, pH, temperature, location and pressure. Information sent from the device 140 may include telemetry information, regarding the capsule ID, time counter, image type data and the status of components in the device, such as current image capturing mode of the imager or estimated remaining power of the device power source.

Device 140 typically may be or may include an autonomous swallowable capsule, but device 140 may have other shapes and need not be swallowable or autonomous. For example, device 140 may be a capsule or other unit where all the components are substantially contained within a container or shell, and where device 140 does not require any wires or cables to, for example, receive power or transmit information. In some embodiments, device 140 may be partially or entirely remote-controllable.

In some embodiments, device 140 may include an in-vivo video camera, for example, imager 146, which may capture and transmit images of, for example, the GI tract while device 140 passes through the GI lumen. Other lumens and/or body cavities may be imaged and/or sensed by device 140. In some embodiments, imager 146 may include, for example, a Charge Coupled Device (CCD) camera or imager, a Complementary Metal Oxide Semiconductor (CMOS) camera or imager, a digital camera, a stills camera, a video camera, or other suitable imagers, cameras, or image acquisition components.

In some embodiments, imager 146 in device 140 may be operationally connected to transceiver 141. Transceiver 141 may transmit images to, for example, external transceiver or receiver/recorder 112 (e.g., through one or more antennas), which may send the data to processor 114 and/or to storage unit 119. Transceiver 141 may also include control capability, although control capability may be included in a separate component, e.g., processor 147. Transceiver 141 may include any suitable transmitter able to transmit image data, other sensed data, and/or other data (e.g., control data, beacon signal, etc.) to a receiving device. Transceiver 141 may also be capable of receiving signals/commands, for example from an external transceiver.

In some embodiments, transceiver 141 may transmit/receive via antenna 148. Transceiver 141 and/or another unit in device 140, e.g., a controller or processor 147, may include control capability, for example, one or more control modules, processing module, circuitry and/or functionality for controlling device 140, for controlling the operational mode or settings of device 140, and/or for performing control operations or processing operations within device 140. According to some embodiments, transceiver 141 may include a receiver which may receive signals (e.g., from outside the patient's body), for example, through antenna 148 or through a different antenna or receiving element. According to some embodiments, signals or data may be received by a separate receiving device in device 140.

Power source 145 may include one or more batteries or power cells. For example, power source 145 may include silver oxide batteries, lithium batteries, other suitable electrochemical cells having a high energy density, or the like. Other suitable power sources may be used. For example, power source 145 may receive power or energy from an external power source (e.g., an electromagnetic field generator), which may be used to transmit power or energy to in-vivo device 140.

Optionally, in some embodiments, transceiver 141 may include a processing unit, processor or controller, for example, to process signals and/or data generated by imager 146. In another embodiment, the processing unit may be implemented using a separate component within device 140, e.g., controller or processor 147, or may be implemented as an integral part of imager 146, transceiver 141 or another component, or may not be needed. The processing unit may include, for example, a Central Processing Unit (CPU), a Digital Signal Processor (DSP), a microprocessor, a controller, a chip, a microchip, a controller, circuitry, an Integrated Circuit (IC), an Application-Specific Integrated Circuit (ASIC), or any other suitable multi-purpose or specific processor, controller, circuitry or circuit. In some embodiments, for example, the processing unit or controller may be embedded in or integrated with transceiver 141, and may be implemented, for example, using an ASIC.

In some embodiments, imager 146 may acquire in-vivo images continuously, substantially continuously, or in a non-discrete manner, for example, not necessarily upon-demand, or not necessarily upon a triggering event or an external activation or external excitation, or in a periodic manner, an intermittent manner, or an otherwise non-continuous manner.

In some embodiments, device 140 may include one or more illumination sources 142, for example one or more Light Emitting Diodes (LEDs), “white LEDs”, or other suitable light sources. Illumination sources 142 may, for example, illuminate a body lumen or cavity being imaged and/or sensed. An optical system 150, including, for example, one or more optical elements, such as one or more lenses or composite lens assemblies, one or more suitable optical filters, or any other suitable optical elements, may optionally be included in device 140 and may aid in focusing reflected light onto imager 146, focusing illuminating light, and/or performing other light processing operations.

In some embodiments, the components of device 140 may be enclosed within a housing or shell, e.g., capsule-shaped, oval, or having other suitable shapes. The housing or shell may be substantially transparent, and/or may include one or more portions, windows or domes that may be substantially transparent. For example, one or more illumination source(s) 142 within device 140 may illuminate a body lumen through a transparent, window or dome; and light reflected from the body lumen may enter the device 140, for example, through the same transparent or portion, window or dome, or, optionally, through another transparent portion, window or dome, and may be received by optical system 150 and/or imager 146. In some embodiments, for example, optical system 150 and/or imager 146 may receive light, reflected from a body lumen, through the same window or dome through which illumination source(s) 142 illuminate the body lumen.

According to one embodiment, while device 140 traverses a patient's GI tract, the device 140 transmits image and possibly other data to components located outside the patient's body, which receive and process the data. Typically, receiving unit 112 is located outside the patient's body in one or more locations. The receiving unit 112 may typically include, or be operatively associated with, for example, one or more antennas, or an antenna array 124, for receiving and/or transmitting signals from/to device 140. Receiving unit 112 typically includes an image receiver storage unit and a control/processing unit 122. According to one embodiment, the image receiver 112 and image receiver storage unit are small and portable, and are typically worn on the patient's body (or located in close proximity to the patient's body) during recording of the images, or at least until the image capturing procedure is determined to be terminated.

In some embodiments, device 140 may communicate with an external receiving and display system (e.g., workstation 117 or monitor 118) to provide display of data, control, or other functions. Data processor 114 in workstation 117 may include a processing unit, processor or controller. The processing unit may include, for example, a CPU, a DSP, a microprocessor, a controller, a chip, a microchip, a controller, circuitry, an IC, an ASIC, or any other suitable multi-purpose or specific processor, controller, circuitry or circuit. Data processor 114 may analyze the data received via external receiver/recorder 112 from device 140, and may be in communication with storage unit 119, e.g., transferring frame data to and from storage unit 119. Data processor 114 may provide the analyzed data to monitor 118, where a user (e.g., a physician) may view or otherwise use the data. For example, data processor 114 may calculate the boundary between the proximal region of the small bowel and the distal region of the small bowel.

In some embodiments, data processor 114 may be configured for real time processing and/or for post processing to be performed and/or viewed at a later time. In the case that control capability (e.g., delay, timing, etc) is external to device 140, a suitable external device (such as, for example, data processor 114 or external receiver/recorder 112 having a transmitter or transceiver) may transmit one or more control signals to device 140.

Monitor 118 may include, for example, one or more screens, monitors or suitable display units. Monitor 118, for example, may display one or more images or a stream of images captured and/or transmitted by device 140, e.g., images of the GI tract or of other imaged body lumen or cavity. The result of the post-duodenal boundary detection, for example, may be displayed to a user, either automatically or upon a user request. Optionally, an indication of the timestamp of the image which was detected as the post-duodenal boundary may be presented, for example, on a time bar of the image stream being viewed. In some embodiments, the user may be presented with several options of a post-duodenal boundary (for example, several image frames may be displayed simultaneously on the monitor, or several indications of the possible location of the boundary may be displayed on a screen showing the path traveled by the in vivo imaging device), and may manually select a preferred option. When presenting several boundary options to the user, a score or degree of confidence (e.g., the result of the error function) may be presented as well. The boundary options may be presented in the order of the detection algorithm's level of confidence. Other indications to the user are possible. Additionally or alternatively, monitor 118 may display, for example, control data, location or position data (e.g., data describing or indicating the location or the relative location of device 140), orientation data, image analysis data, and various other suitable data. In some embodiments, for example, both an image and its position (e.g., relative to the body lumen being imaged) or location may be presented using monitor 118 and/or may be stored using storage unit 119. Other systems and methods of storing and/or displaying collected image data and/or other data may be used.

Typically, device 140 may transmit image information in discrete portions. Each portion may typically correspond to an image or a frame; other suitable transmission methods may be used. For example, in some embodiments, device 140 may capture and/or acquire an image once every half second, and may transmit the image data to the external receiving unit 112. Other constant and/or variable capture rates and/or transmission rates may be used.

While the present invention has been described with reference to one or more specific embodiments, the description is intended to be illustrative as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for automatically detecting a post-duodenal boundary in an image stream of the gastrointestinal tract, using a processor, comprising:
resampling the image stream to obtain a reduced set of images;
filtering the reduced set of images to remove non-valid images or non-valid portions of images, thereby obtaining a set of valid images to be subsequently processed;
generating a polar representation of the valid images;
processing textural features of the polar representation of the filtered set of images; and
detecting the post-duodenal boundary.

2. The method according to claim 1 further comprising: classifying the images frames as belonging to the proximal region of the small bowel or to the distal region of the small bowel.

3. The method according to claim 1 wherein processing textural features includes applying a bank of Gabor filters.

4. The method according to claim 3 comprising: performing half-wave rectification after applying the bank of Gabor filters.

5. The method according to claim 1 wherein detecting the post-duodenal boundary comprises: computing the best fit to a step function to estimate the post-duodenal boundary.

6. The method according to claim 1 comprising: displaying an indication of the detected post-duodenal boundary to a user.

7. The method according to claim 1 wherein filtering the reduced set of images to remove non-valid images or non-valid portions of images includes removing images or portions of images which include intestinal content, bubbles or artefacts.

8. The method according to claim 7 comprising determining a threshold for removing images which include a non-valid portion which is larger than said threshold.

9. The method of claim 1 comprising detecting turbid intestinal contents.

10. The method of claim 1 wherein resampling the image stream includes keeping one out of every n images of the image stream.
